(19) United States
(12) Patent Application Publication
(10) Pub. No.: US 2011/0294416 A1
(43) Pub. Date: Dec. 1, 2011

(54) SYSTEM FOR POSITIONING A GEOSTATIONARY SATELLITE

(75) Inventor: Bruno CELERIER, Cannes (FR)

(73) Assignee: THALES, Neuilly Sur Seine (FR)

(21) Appl. No.: 13/118,216

(22) Filed: May 27, 2011

(30) Foreign Application Priority Data
Jun. 1, 2010 (FR) 10 02309

(51) Int. Cl. H04B 17/02

(52) U.S. Cl. 455/9

(57) ABSTRACT

A system for positioning a geostationary satellite includes: at least four earth stations each being in a known position and capable of sending to the satellite a signal called an uplink signal, and means for measuring the differences in the arrival times of the uplink signals at the satellite.

### CROSS-REFERENCE TO RELATED APPLICATION

This application claims priority to foreign French patent application No. FR 1002309, filed on Jun. 1, 2010, the disclosure of which is incorporated by reference in its entirety.

### FIELD OF THE INVENTION

The field of the invention is that of determining the position of a geostationary satellite.

### BACKGROUND

It is known practice to determine the position of a geostationary satellite by using a system comprising a dedicated station for measuring distance between this station and the satellite, such as a large transmitter and receiver TCR (the acronym for Telemetry Command and Ranging) station in a known position and a specific transponder on board the satellite, included in the TCR subsystem. The orbit of the satellite is determined on the basis of several timings of the return journey between the station and the satellite. These measurements of the propagation time are sometimes verified or supplemented by measurements of the azimuth and elevation of the signal received by the station.

One of the drawbacks of this system is that the transmitter and receiver station requires large mobile antennas which are expensive to acquire and maintain, difficult to make robust because of the use of mobile and motorized parts. The unfortunate consequence of this is that the orbit control chain may become unavailable and hence the functions normally performed such as the measurement of distance, the calculation of manoeuvres and other operations.

Another satellite positioning system described in U.S. Pat. No. 6,229,477 uses a transmitter and receiver station called a primary station and at least one other receiver and transmitter station called a secondary station. The primary station sends a measurement signal to the satellite which returns it to the primary station and to the secondary stations. The secondary stations then return response-code signals to the primary station via the satellite. The primary station determines the position of the satellite as a function of:
on the one hand the primary station-satellite propagation time based on the arrival time of the measurement signal and
on the other hand the Doppler frequency shift established on the basis of the carrier frequency difference between the measurement code sent and the response code received from the secondary stations.

This system based notably on measurements of journeys, requires the primary station to be fitted with a local clock and the departure time of the measurement signal to be recorded. The position obtained is then riddled with errors due to the transmission delays of the satellite and the repeating delays of the secondary stations.

Another satellite positioning system described in U.S. Pat. No. 7,512,505 uses
a station that is the transmitter of a signal to the satellite and the receiver of the corresponding signal returned by the satellite, and
several other stations for receiving the downlink signal returned by the satellite.

This system based on measurements of arrival time requires on the one hand that each receiver station is fitted with a local clock and that these stations be synchronized with one another and on the other hand requires a network for collecting the measurements taken by the receiver stations and sent to a computer centre.

It is also possible to cite patent EP 2 148 214 which proposes a system comprising several receiver stations for receiving a signal sent by the satellite and a station for collecting and processing the data sent by the receiver stations. Each receiver station records during a determined time window the signals transmitted by the satellite and sends to the processing station the data representing the signals received during the said time window. The time window associated with each station is shifted and/or of a different size from one station to another.

As in the above case, this system based on measurements of arrival time requires on the one hand that the receiver stations be synchronized with one another in order to determine the time windows and on the other hand requires a network for collecting the measurements taken by the receiver stations and to be sent to the processing station.

The object of the invention is to provide a reliable system that is as powerful and less costly than the current solutions for determining the position of the satellites.

### SUMMARY OF THE INVENTION

The solution consists in using the well known technique of TDOA “Time Differences Of Arrival”, in association with a system such that all the measurements are taken in one and the same location, either on board the satellite or at any point in its coverage area, thus dispensing with any system for collecting the data in one and the same location.

It is therefore compatible with low-cost earth stations, and even with the reuse of earth resources dedicated to each satellite, such as the existing antennas for transmission from the earth, and “uplink” to the satellite, of the content to be broadcast by it.

More precisely, the subject of the invention is a system for positioning a geostationary satellite mainly characterized in that it comprises:
at least four earth stations each being in a known position and capable of sending to the satellite a signal called an uplink signal,
and means for measuring the differences in the arrival times of the uplink signals at the satellite.

According to a first embodiment of the system according to the invention, the earth stations are transmitter stations for transmitting the uplink signals generated by themselves and they comprise means for synchronizing between them the transmission of the uplink signals.

These synchronization means of each earth station comprise for example means for receiving a GNSS-type satellite positioning signal. Specifically this type of signal includes a reference clock signal.

According to a second embodiment of the system according to the invention, the earth stations are repeater stations, each uplink signal being the repeat of a downlink signal sent by the satellite.

In this case, no synchronization of the uplink signals is necessary. It is therefore not necessary in this embodiment for the earth stations to be fitted with means for synchronizing with one another.

The satellite comprises for example means for generating the downlink signal.

According to one variant, the downlink signal sent by the satellite is transmitted by a transmitter earth station and repeated by the satellite, the satellite comprising means for repeating the signal received from the transmitter earth station. This transmitter earth station may be one of the repeater stations.

According to one feature of the invention, the means for measuring the time differences of arrival at the satellite of the uplink signals are installed in a measuring earth station and the satellite comprises means for returning the uplink signals to the measuring earth station.

According to one feature of the invention, the uplink signals are of the same frequency and shifted in time by a known delay, the shift being made either by the transmitter earth stations or by the repeater earth stations.

### BRIEF DESCRIPTION OF THE DRAWINGS

Other features and advantages of the invention will become evident on reading the following detailed description made as a non-limiting example and with reference to the appended drawings in which:

FIG. 1a represents schematically an example of a satellite location system according to the invention, with earth stations for transmitting an uplink signal,

FIG. 1b represents schematically the example of a satellite location system of FIG. 1a with the satellite synchronization means,

FIG. 2a represents schematically an example of a satellite location system according to the invention with earth stations that are repeater stations for repeating a downlink signal generated by the satellite to be located,

FIG. 2b represents schematically an example of a satellite location system according to the invention, with earth stations that are repeater stations for repeating a downlink signal repeated by the satellite to be located, and originating from a transmitter earth station,

FIG. 3 represents schematically the example of a satellite location system according to the invention of FIG. 1a, the uplink signals received by the satellite being repeated to a processing earth station.

From one figure to another, the same elements are identified by the same reference numbers.

### DETAILED DESCRIPTION

The invention consists in determining the position of a geostationary satellite:
by exploiting the principle of TDOA, “Time Differences Of Arrival”,
by using the signal-transmitting or -repeating capabilities specific to this category of satellites, that is to say a receive antenna, a repeater (an electronic member delivering the information of the received signal to another carrier signal capable of being forwarded), and a forwarding antenna which physically can be the receive antenna,
and by measuring the time differences of arrival of the signals due to the journey differences of the signals:
   earth station to satellite, or
   satellite→earth station→satellite, in which case the time differences of arrival are doubled,
the measurement being made:
   either on board the satellite,
   or on the earth, after the signals have been returned by the satellite to the earth.

The uplink signals involved in these measurements contain no information other than their own existence, or if they contain information because they are based on existing signals, this information is neither of any use nor exploited to determine the position of the satellite.

The various embodiments will now be explained in detail. The basic system comprises:
at least four earth stations each being in a known position and capable of sending to the satellite a signal called an uplink signal,
and means for measuring the differences in the arrival times of the uplink signals at the satellite.

The solution satisfies the requirement by providing a solution that is economical and easy to make reliable:
the low-cost earth stations may be disposed in sufficient number (at least four, which is the mathematical minimum for the use of TDOA) so that the system remains in operation including when one station is unavailable for a minor or also a major unforeseen event (a seismic or climatic event for example),
the transmitter and receiver stations may reuse various existing structures, typically for the “uplinking” of the telecommunications signals to be broadcast, which structures usually already exist in several locations of the coverage area.

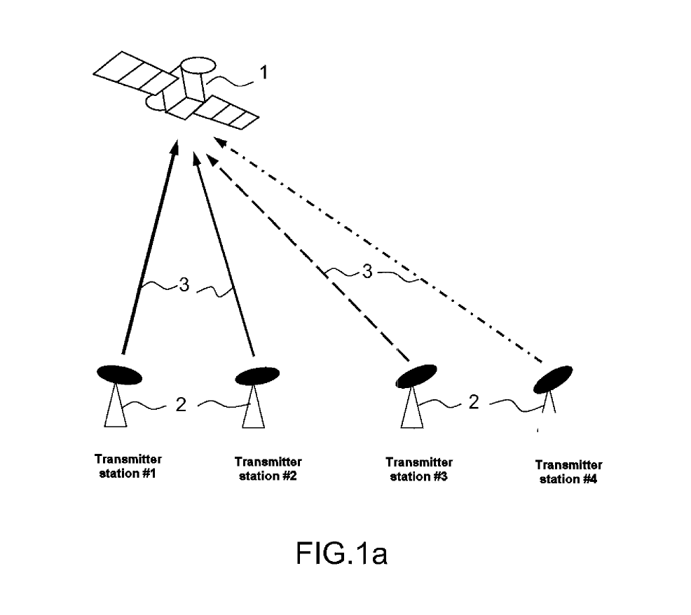

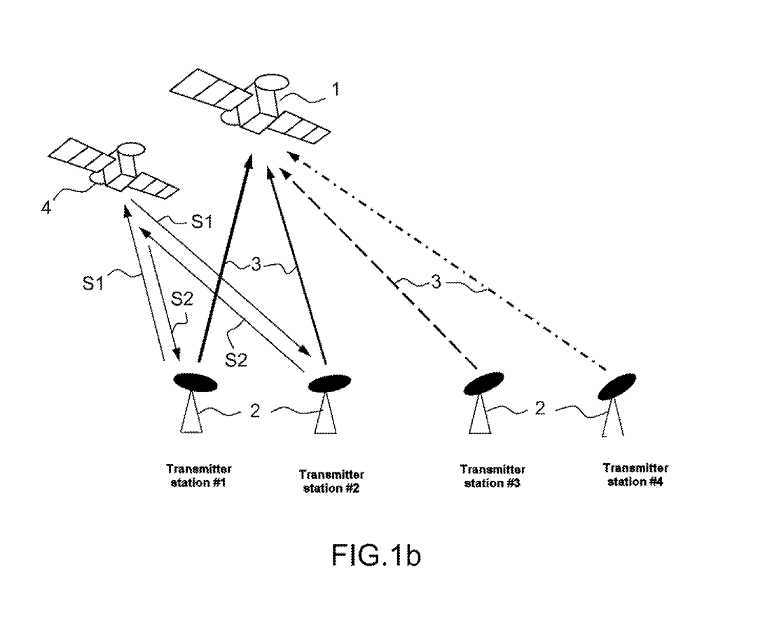

According to a first embodiment described with reference to FIG. 1a, the earth stations are transmitter stations 2 for transmitting an uplink signal 3 each station itself generating the signal. This signal 3 is for example in “burst” form, a “burst” signal being a sine wave signal with a duration limited to a time window.

The same frequency may be used by each station since the times of arrival are different. These earth stations are synchronized with one another for a synchronized transmission of the uplink signals. From one station to the other, a known delay may also be applied to the transmission of these uplink signals.

The time difference of arrival is measured on board by means of a specific item of hardware installed on board the satellite.

This may be for example by using logarithmic amplifiers that are well known in this application and described for example in the publication “Detecting Fast RF Bursts using Log Amps” by Yuping Toh (Analog Dialogue 36-05 (2002)), followed by a comparator of electric voltages the state transition of which triggers the starting or the storing of the progression of an oscillator, capable of providing the elapsed time between two successive “bursts” through the knowledge of the oscillator period.

Another solution, more elegant, more precise, more complex, but very well known to those skilled in the art, is to use the advantages of the spread spectrum, such as CDMA, the acronym for Code Division Multiple Access, for generating the signal, with for example the “early-late” technique for determining its moment of arrival. This TOA difference is in the form of a number of known duration periods, available in a memory register.

This solution provides the possibility of determining orbit on board, and of programming and executing station-holding manoeuvres autonomously. Moreover, no data collection system is necessary: the time differences of arrival are measured at one and the same point.

The means for synchronizing each earth station may take different configurations. These synchronization means are for example based on a Global Navigation Satellite System (GNSS) such as the GPS or Galileo system. The synchronization means then comprise a receiving device of such a GNSS system which receives a reference clock signal. As shown in FIG. 1b, it may also be a satellite synchronization system 4, as based on the transmission of bidirectional signals between the stations, the departure of which is timed by the transmitter station and the arrival is timed by the receiver station. More precisely, each transmitter station 2 may be synchronized by a reference clock signal in the following manner:
A) transmitter station #1 sends via the satellite 4 a signal s1 to another station #i (in the figure and hereinafter the example of i=2 will be taken) with a time of departure (or “TOD”),
B) transmitter station #2 sends a signal s2 to station #1 with a time of departure (“TOD”), and the TOA of the signal s1 sent in step A).

This finally gives the time shift of station #2 versus station #1: ((TOAs1−TODs1)−(TOAs2−TODs2))/2

In this situation, because of the signals interchanged in the previous protocol, only station #1 has all the data necessary for the calculation.

Station #i may also have the data, for example by regularly repeating these interchanges and by adding to step A, by transmitting with s1 of the TOA the last signal s2 received by the station: all the stations then operate in exactly the same manner.

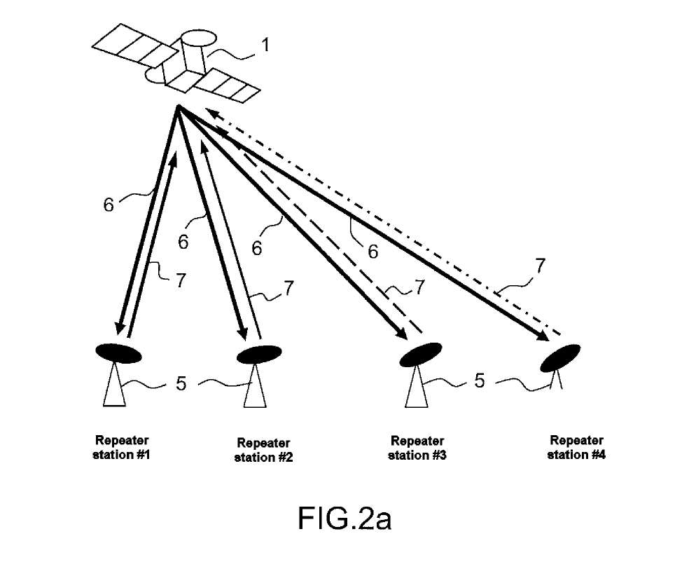

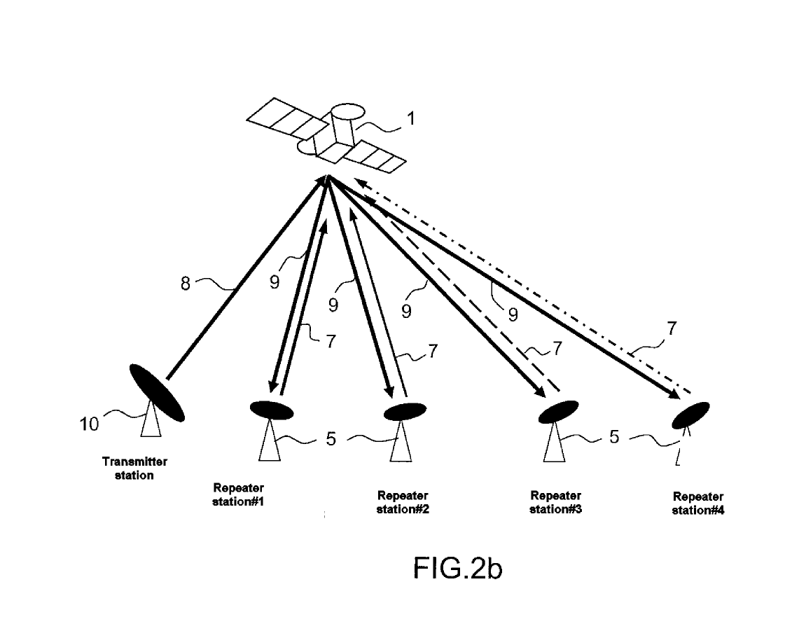

According to a second embodiment, the examples of which are shown in FIGS. 2a and 2b, the earth stations are repeater stations 5, each uplink signal 7 being the repeat by this station of the downlink signal 6 sent by the satellite. This downlink signal 6 is for example in the “burst” form already cited, and at different or identical frequencies. It may also be, for example, a telemetry signal of the state variables of the satellite (temperatures, electric voltages, altitude measurements, etc.) or a payload signal (data, and/or audio, and/or video).

These earth stations may also transmit an uplink signal that may differ from the downlink signal but is synchronized on receipt of this downlink signal (beginning, end, detection of a keyword, etc.). “Synchronized” in this instance means that the delay between the receipt of the signal 6 and the transmission of the signal 7 is constant as the successive transmissions progress and has an identical duration between the stations, or known durations for each station (if only by measurement) for taking account of the time differences of arrival in the calculation.

No synchronization between the uplink signals 7 is necessary; it is therefore not necessary for the earth stations 5 to be fitted with means of synchronization between them. The same frequency may be used by each station since the times of arrival are different. It will be possible however, if necessary for the electronic application, to increase the differences of reception of the various signals 7 by the satellite by applying a known delay (predetermined and/or measured more precisely as usage progresses) and different from one station to another at the time of repetition by the stations of the same name. As for the previous embodiment, the time difference of arrival is measured on board by means of an item of specific hardware installed on board the satellite. Because of the return journey, these differences are double those of the first embodiment. This difference in TOA is in digital form, identical to that described in the first embodiment, or different, analogue for example.

This solution offers the same advantages:
the possibility of determining the orbit on board, and the programming and execution of the station-holding manoeuvres in an autonomous manner,
no data collection system is necessary since the time differences of arrival are measured at one and the same point.

Moreover, this solution has an additional advantage: the earth station 5 is less costly and more reliable, an item of repeater equipment being less costly than an item of transmitter equipment furnished with synchronization means, and is not subject to a possible failure of the synchronization system.

The downlink signal sent by the satellite can be generated on board the satellite as in the example illustrated in FIG. 2a. The satellite is then fitted with means for transmitting a signal, for example similar to that which exists for the sending to earth of telemetry of the states of the satellite.

According to a variant illustrated in FIG. 2b, the downlink signal 9 itself originates from a signal 8 transmitted by a transmitter earth station 10, which signal is repeated by the satellite 1. The satellite is then fitted with a repeater compatible with the frequency or frequency band and with the level of the signal to be repeated. The signals 8 and 9 are for example in “burst” form also.

According to a particular embodiment, one of the repeater earth stations 5 is supplemented so as to perform this function of a transmitter station.

In the examples presented hitherto, the time difference of arrival is measured by means of a specific item of hardware installed on board the satellite 1.

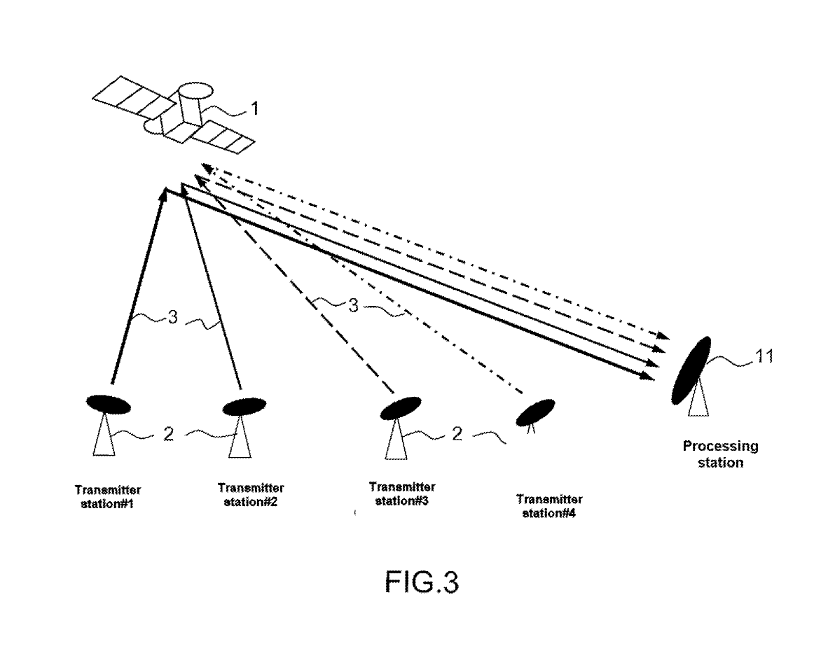

According to an alternative, the uplink signals are repeated by the satellite 1 to a processing earth station 11, shown in FIG. 3, which measures the time differences of arrival and deduces the position of the satellite 1 therefrom. This repeating to a processing station 11 can be carried out in the situation explained with reference to FIG. 1, but also for the situations explained with reference to FIG. 2. Here again, the time differences of arrival are measured at one and the same point, in this instance the processing earth station 11. It will be noted that the time differences of arrival in fact correspond to the time of arrival at the satellite TOAsat because: TOAst=TOAsat+constant,

TOAst being the time of arrival at the processing station 11. The constant disappears when the time differences of arrival are measured.

This solution requires no specific hardware on board the satellite 1 to determine the time differences of arrival. On the other hand, the information calculated on the earth can be sent by uplink to the satellite 1 for example by remote control means that exist and are widely used for controlling the satellite and keeping it operational, so that the determination of orbit and the programming and execution of the manoeuvres for holding station can be carried out autonomously.

One of the repeater stations or a transmitter station may be supplemented in order to perform this processing station function.

The geostationary satellite 1 to be located is for example a telecommunications satellite or an observation or weather satellite.

1. A system for positioning a geostationary satellite, comprising:
at least four earth stations each being in a known position and capable of sending to the satellite a signal called an uplink signal, and
means for measuring the differences in the arrival times of the uplink signals at the satellite.

2. The system for positioning a geostationary satellite according to claim 1, wherein the earth stations are transmitter stations for transmitting the uplink signals generated by themselves, which comprise means for synchronizing between them the transmission of the uplink signals.

3. The system for positioning a geostationary satellite according to claim 2, wherein the synchronization means of each earth station comprise means for receiving a GNSS-type satellite positioning signal.

4. The system for positioning a geostationary satellite according to claim 1, wherein the earth stations are repeater stations, each uplink signal being the repeat of a downlink signal sent by the satellite.

5. The system for positioning a geostationary satellite according to claim 4, wherein the satellite comprises means for generating the downlink signal.

6. The system for positioning a geostationary satellite according to claim 5, wherein the downlink signal sent by the satellite is transmitted by a transmitter earth station and repeated by the satellite, the satellite comprising means for repeating the signal received from the transmitter earth station.

7. The system for positioning a geostationary satellite according to claim 6, wherein the transmitter earth station is one of the repeater stations.

8. The system for positioning a geostationary satellite according to claim 1, wherein the means for measuring the time differences of arrival at the satellite of the uplink signals are installed on board the satellite.

9. The system for positioning a geostationary satellite according to claim 1, wherein the means for measuring the time differences of arrival at the satellite of the uplink signals are installed in a measuring earth station and the satellite comprises means for returning the uplink signals to the measuring earth station.

10. The system for positioning a geostationary satellite according to claim 1, wherein the signals are of the same frequency and shifted in time by a known delay.
